(19) United States
(12) Patent Application Publication
(10) Pub. No.: US 2011/0128671 A1
(43) Pub. Date: Jun. 2, 2011

(54) SUPERCAPACITORS AND METHODS FOR PRODUCING SAME

(76) Inventors: Yury Gogotsi, Warminster, PA (US); John Chmiola, Plains, PA (US); Gleb Yushin, Atlanta, GA (US); Patrice Simon, Toulouse (FR); Cristelle Portet, Carcassonne (FR); Pierre-Iouis Taberna, Toulouse (FR)

(21) Appl. No.: 12/300,406

(22) PCT Filed: May 15, 2007
(86) PCT No.: PCT/US07/11490

§ 371 Date: May 26, 2009

Related U.S. Application Data
(60) Provisional application No. 60/800,575, filed on May 15, 2006.

(51) Int. Cl. H01G 9/004; C01B 31/00; H01B 1/04; H01M 6/00

(52) U.S. Cl. 361/500; 423/445 R; 252/502; 29/623.4

(57) ABSTRACT

Disclosed are microporous carbon compositions suitable for use in supercapacitor devices, which compositions comprise pores having an average characteristic cross-sectional dimension of less than about 1 nm. Also described are electrodes and electrochemical cells that utilize the disclosed compositions and methods of making the disclosed compositions.

### CROSS-REFERENCE TO RELATED APPLICATIONS

This application claims the benefit of U.S. Provisional Application No. 60/800,575, filed on May 15, 2006, the entirety of which is incorporated by reference herein.

### STATEMENT OF GOVERNMENT INTEREST

The U.S. Government may have certain rights in the present invention. This work was partially supported by National Science Foundation IGERT grant number 0221664.

### FIELD OF THE INVENTION

The present invention pertains to the field of nanoporous materials. The present invention also pertains to the field of electric capacitors.

### BACKGROUND OF THE INVENTION

Supercapacitors, also called electrical double layer capacitors (EDLC), are electrochemical energy storage devices akin to batteries (Conway, B. E., Electrochemical Capacitors: Scientific Fundamentals and Technological Applications (Kluwer 1999)). Occupying a region between batteries and dielectric capacitors on the Ragone plot describing the relationship between energy and power (Conway, B. E., Electrochemical Capacitors: Scientific Fundamentals and Technological Applications (Kluwer 1999)), supercapacitors have been described as a solution to rapid growth in power required by devices and the inability of batteries to efficiently discharge at high rates (Arico et al., Nat. Mater, 2005, 4:366; Brodd et al., J. Electrochem. Soc., 2004, 151:K1).

This large capacity for high power discharge is directly related to the absence of charge transfer resistances that are a consequence of battery Faradaic reactions, and subsequently leads to low temperature dependence and theoretically unlimited cyclability in supercapacitors. Improvements in the energy density of supercapacitors may enhance current batteries, helping usher electrical and fuel cell cars to the road, as well as enabling numerous applications for supercapacitors (Woolfe, G., in Batteries and Energy Storage Technology, 2005, Vol. 3, pp. 107-113). Though strides have been made in cell packaging and electrolytes (Barisci et al., Electrochem. Commun., 2004, 6:22; Rudge et al., J. Power Sources, 1994, 47:89), challenges in electrode material design have limited energy density, effectively limiting wide-scale usage of supercapacitors.

Unlike batteries and fuel cells that harvest energy stored in chemical bonds, supercapacitors exploit the electrostatic separation between electrolyte ions and high surface area electrodes, typically carbon (Conway, B. E., Electrochemical Capacitors: Scientific Fundamentals and Technological Applications (Kluwer 1999)). Thus, unlike traditional dielectric capacitors that have capacities typically measured in microfarads, capacitances of supercapacitors are measured as tens of Farads per gram of active material. Energy stored in a supercapacitor is linearly proportional to the capacitance of its electrodes, which highlights the need to optimize materials used in supercapacitors.

The large capacitance, C, and hence energy storage potential, of supercapacitors arises due to the small—approximately 1 nm—separation between electrolyte ions and carbon, d, and high, typically in the range of from about 500 m²/g to about 2000 m²/g, specific surface area (SSA) of carbon electrodes according to the fundamental equation governing capacitance:

$$C = \frac{ɛ A}{d} \qquad ( 1 )$$

where A represents the electrode surface area accessible to electrolyte ions, and E is the electrolyte dielectric constant. As SSA relates explicitly to pore size, understanding its effect on specific capacitance has been the subject of numerous studies over the past decade (Beguin, F., Carbon, 2001, 39:937; Gamby et al., Power Sources, 2001, 101:109).

Traditional methods of producing porous carbon from either natural precursors such as coconut shells or synthetic precursors such as phenolic resin do not, however, always offer sufficient control over porosity (Beguin, F. and Frackowiak, E. in Nanomaterials Handbook, Ed. Y. Gogotsi (CRC Press, Boca Raton, 2006) pp. 713-737) for all applications. Mesoporous carbons synthesized using template techniques have produced controllable pores in the 2-4 nm range (Zhou et al. J., Power Sources, 2003, 122:219). Over the past two decades, multiple reports on mesoporous carbons for supercapacitors have shown that pores significantly larger than the size of the electrolyte ion and its solvation shell are required to maximize capacitance. Carbon nanotubes have provided a good model system with large pores and high conductivity, leading to impressive power densities (Baughman et al., Science, 2002, 297:787), but low energy density.

Despite the advances in supercapacitor materials, there is nevertheless a need for a material of controllable porosity capable of equaling or surpassing the energy storage potential of existing supercapacitors. There is also an attendant need for methods for fabricating such supercapacitor materials.

### SUMMARY OF THE INVENTION

To meet the challenges of providing enhanced supercapacitor materials, the present invention provides, inter alia, a composition, comprising: a microporous carbon composition comprising a plurality of pores and characterized as having an average characteristic cross-sectional dimension as determined by the non-local density functional theory method analysis of nitrogen sorption isotherms, of less than about 1 nm.

Also provided is a method for making a microporous carbon composition characterized as having an average pore size of less than about 1 nm, comprising: halogenating a metal carbide powder at a temperature in the range of from about 500° C. to about 1000° C. to give rise to a microporous carbide-derived carbon composition; and annealing the microporous carbide-derived carbon composition to remove residual chlorine and chlorides trapped in the pores of the microporous carbide-derived carbon composition.

Further provided is an electrode, comprising: a microporous carbon composition characterized as having an average pore size of less than about 1 nm. The present invention also provides a method of making an electrode, comprising: preparing a film comprising a microporous carbide-derived carbon composition characterized as having an average pore size of less than about 1 nm.

Also disclosed is an electrochemical cell, comprising: at least one electrode comprising a microporous material characterized as having an average pore size of less than about 1 nm; at least one current collector in electrical connection with the at least one electrode, wherein the at least one current collector comprises a conducting material; and an electrolyte directly contacting the at least one electrode.

Additionally disclosed is a method for making an electrochemical cell, comprising: adhering at least one electrode to at least one current collector, wherein the at least one electrode comprises a microporous composition characterized as having an average pore size of less than about 1.2 nm, as determined by the non-local density functional theory method analysis of nitrogen sorption isotherms, and contacting the at least one electrode with an electrolyte, wherein the electrolyte comprises a plurality of solvated ions, a plurality of unsolvated ions, or any combination thereof.

The general description and the following detailed description are exemplary and explanatory only and are not restrictive of the invention, as defined in the appended claims. Other aspects of the present invention will be apparent to those skilled in the art in view of the detailed description of the invention as provided herein.

### BRIEF DESCRIPTION OF THE DRAWINGS

The summary, as well as the following detailed description, is further understood when read in conjunction with the appended drawings. For the purpose of illustrating the invention, there are shown in the drawings exemplary embodiments of the invention; however, the invention is not limited to the specific methods, compositions, and devices disclosed. In addition, the drawings are not necessarily drawn to scale. In the drawings:

FIG. 1A illustrates Raman spectroscopy behavior of a representative sample of nanoporous carbide-derived carbon (“CDC”) showing a decreasing I_{D}/I_{G} ratio (the ratio of the areas under the D-band and G-band curves) with increasing synthesis temperature, TEM micrographs of titanium carbide-based carbide-derived carbon (“TiC-CDC”) produced at (FIG. 1B) 600° C., (FIG. 1C) 800° C., and (FIG. 1D) 1000° C. show slight ordering as evidenced by increasing length of graphite fringes, as well as their flattening;

FIG. 2 provides porosity information resolved from gas sorption data for a representative sample of TiC-CDC;

FIG. 3A depicts the decrease in specific capacitance and volumetric capacitance for a representative sample with synthesis temperature (maximum capacitance occurred at about 600° C. synthesis temperature) a plot of characteristic time constant, τₒ, versus synthesis temperature (inset), and FIG. 3B compares TiC-CDC charge-discharge behavior with commercially available carbons;

FIG. 4A illustrates normalized capacitance decreasing with pore size for a representative sample until a critical value is reached, as distinguished from traditional understanding which assumed capacitance continually decreased, FIG. 4B illustrates solvated ions residing in pores with distance between adjacent pore walls greater than 2 nm, (FIG. 4C), between 1 nm and 2 nm, and (FIG. 4D) less than 1 nm—data points designated [8] are from Gamby, et al., J. Power Sources, 2001, 101, 109 and data points designated [26] are from Dzubiella, et al., J. Chem. Phys., 2005, 122, 23706;

FIG. 5A depicts isotherms for representative TiC-CDC samples synthesized in the 500° C. to 1000° C. range, showing increasing pore volume with synthesis temperature, FIG. 5B illustrates a pore size distribution for TiC-CDC synthesized at 500° C., and FIG. 5C illustrates the pore size distribution for TiC-CDC synthesized at 1000° C.; and

FIG. 6A illustrates imaginary capacitance C″ versus frequency for a representative sample, FIG. 6B illustrates for a representative sample real capacitance C′ normalized by capacitance measured at 1 mHz (C_{LF}) versus frequency, and Nyquist plots (FIG. 6C) for the same representative sample.

FIG. 7 illustrates the capacitance of the positive electrode (C+), negative electrode (C−), and total cell (C) as a function of CDC synthesis temperature, normalized by electrode mass (FIG. 7(a)) and volume (FIG. 7(b)) calculated from the discharge slope between 2.3V and 0V at a current of 5 mA/cm²;

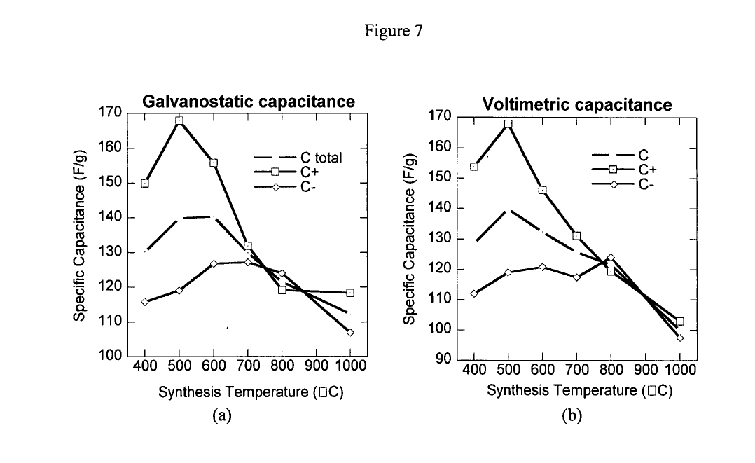

FIG. 8(a) illustrates the specific capacitance of the positive electrode, negative electrode, and total capacitance as a function of CDC pore size, FIG. 8(b) illustrates the volumetric capacitance of the positive electrode (C+), the negative electrode (C−), and of the total cell (C) for a representative sample;

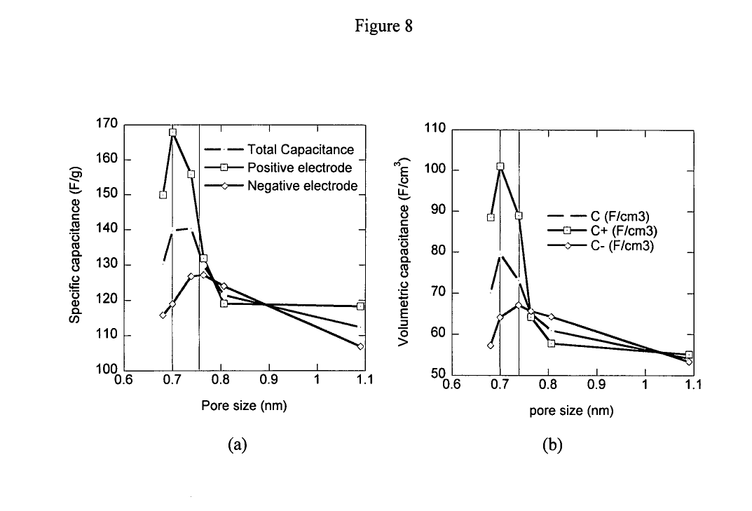

FIG. 9(a) illustrates the capacitance normalized by BET SSA versus pore size and FIG. 9(b) illustrates the capacitance normalized by DFT SSA versus pore size so as to show how an incremental change in surface area leads to capacitance—the normalized capacitance for both the anode and cathode increased with decreasing pore size below about 0.8 nm.

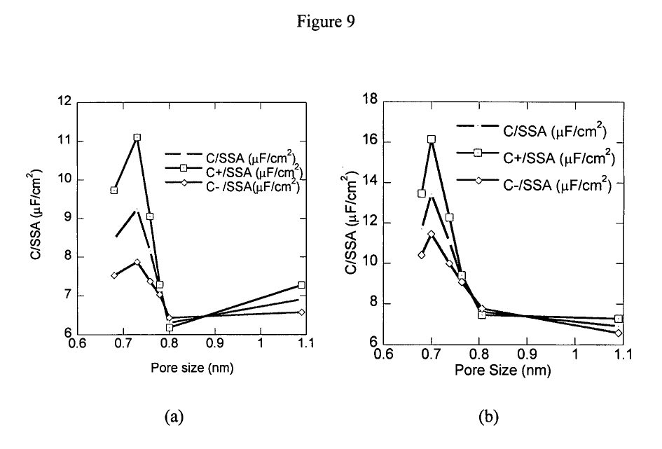

The present invention may be understood more readily by reference to the following detailed description taken in connection with the accompanying figures and examples, which form a part of this disclosure. It is to be understood that this invention is not limited to the specific devices, methods, applications, conditions or parameters described and/or shown herein, and that the terminology used herein is for the purpose of describing particular embodiments by way of example only and is not intended to be limiting of the claimed invention. Also, as used in the specification including the appended claims, the singular forms “a,” “an,” and “the” include the plural, and reference to a particular numerical value includes at least that particular value, unless the context clearly dictates otherwise. The term “plurality”, as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable.

It is to be appreciated that certain features of the invention which are, for clarity, described herein in the context of separate embodiments, may also be provided in combination in a single embodiment. Conversely, various features of the invention that are, for brevity, described in the context of a single embodiment, may also be provided separately or in any subcombination. Further, reference to values stated in ranges include each and every value within that range.

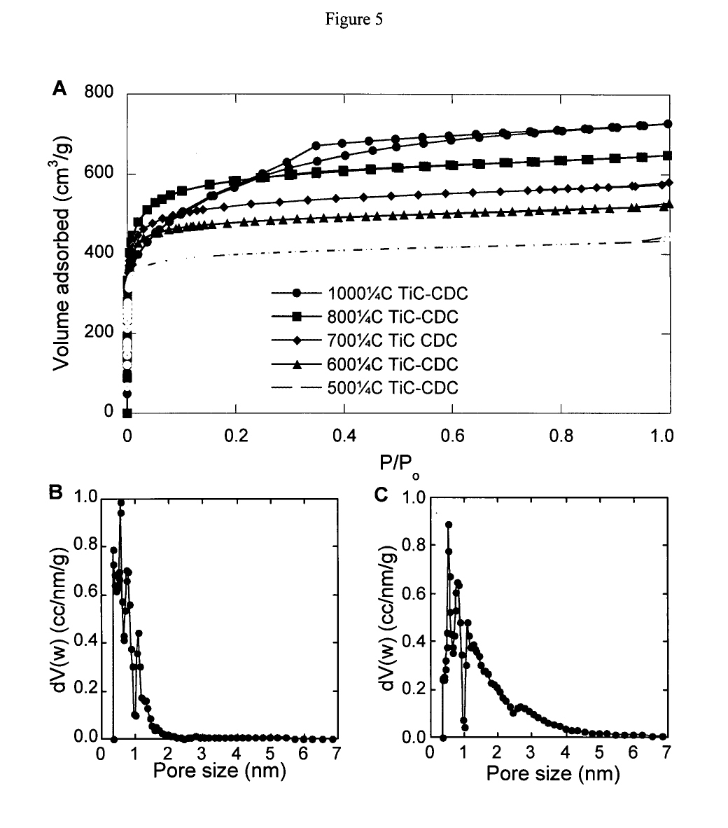

Provided are compositions, such compositions including a microporous carbon composition comprising a plurality of pores and characterized as having an average characteristic cross-sectional dimension as determined by the non-local density functional theory method analysis of nitrogen sorption isotherms, of less than about 1 nm. In the inventive compositions, the plurality of pores can be characterized as being substantially slit-shaped, as being substantially cylindrical in shape, or some combination of the two. The plurality of pores can have an average characteristic cross-sectional dimension as determined by the non-local density functional theory method analysis of nitrogen sorption isotherms, of less than about 2 nm, or of less than about 1 nm, of less than about 0.9 nm, or even of less than about 0.8 nm. The microporous carbon composition may, in some embodiments, be characterized as having a unimodal pore size distribution; see FIGS. 5B, 5C.

The microporous carbon composition can consist essentially of carbide-derived carbon. The composition may also contain essentially no ordered graphite, and, in some cases, may be substantially disordered in structure.

The composition may be characterized as having a surface area calculated by the Brunauer, Emmett and Teller method in the range of from about 800 m²/g to about 3000 m²/g, or in the range of from about 1000 m²/g to about 2000 m²/g. The composition may also be characterized as having a specific capacitance greater than about 90 F/g in an organic electrolyte, and can also be characterized as having a gravimetric capacitance calculated by the Brunauer, Emmett and Teller method of greater than about 5 μF/cm².

Also disclosed are methods for making microporous carbon compositions characterized as having an average pore size of less than about 1 nm. The methods include halogenating a metal carbide powder at a temperature in the range of from about 500° C. to about 1000° C. to give rise to a microporous carbide-derived carbon composition; and also annealing the microporous carbide-derived carbon composition to remove residual chlorine and chlorides trapped in the pores of the microporous carbide-derived carbon composition.

TiC powder (available from Alfa Aesar, www.alfaaesar.com) is a suitable metal carbide powder. Other suitable metal carbides are known to those in the art.

Annealing can include exposing the microporous carbide-derived carbon composition to a flow of hydrogen. Nitrogen, ammonia, argon, helium, or combinations thereof are also considered suitable annealing species. Flow rates of gases used in annealing can be in the range of from about 5 cubic centimeters per minute to about 1000 cubic centimeters per minute, or from about 10 cubic centimeters per minute to about 100 cubic centimeters per minute, or even from about to about 100 cubic centimeters per minute to about 500 cubic centimeters per minute. Annealing may proceed for from about 5 minutes to about 600 minutes, or from about 10 minutes to about 100 minutes, or from about 30 minutes to about 60 minutes. Annealing can proceed in the temperature range of from about 350° C. to about 1000° C. Compositions synthesized by the claimed methods are also contemplated as part of the invention.

The present invention also includes electrodes. Such electrodes include a microporous carbon composition characterized as having an average pore size of less than about 1 nm.

Suitable microporous carbon compositions are described elsewhere herein. Such compositions suitably consist essentially of carbide-derived carbon. In addition to the microporous carbon compositions described elsewhere herein, electrodes suitably include a binder. Suitable binders may be capable of adhering together the various components of the electrical cell, and include pastes, metallic compounds, polyvinylidene fluoride (PVDF) (Atofina, Inc., www.atofina.com), polytetrafluoroethylene (PTFE) (DuPont, Inc., www.dupont.com) and the like. Binders may be used to construct electrodic devices in a variety of configurations; the optimal configuration will vary based on the user's needs.

Also disclosed are methods for fabricating electrodes, which methods include preparing a film comprising a microporous carbide-derived carbon composition characterized as having an average pore size of less than about 1 nm. Suitable microporous, carbide-derived carbon compositions are described elsewhere herein, as are methods for preparing microporous carbide-derived compositions. The present invention also includes electrodes made according to the disclosed methods.

Further provided are electrochemical cells, which cells are suitably used as capacitors or even as supercapacitors. Such cells suitably include at least one electrode comprising a microporous material characterized as having an average pore size of less than about 2 nm; at least one current collector in electrical connection with the at least one electrode, wherein the at least one current collector comprises a conducting material; and an electrolyte suitably in direct contact with the at least one electrode.

The inventive electrochemical cells can, in some embodiments, include at least two electrodes, such electrodes suitably formed of a microporous material characterized as having an average pore size of less than about 1 nm and at least two current collectors, each current collector in contact with an electrode, and the electrolyte directly contacting each of the electrodes.

Suitable current collectors include conductive structures which can be in the form of a wire, sheet or other shape. Current collectors may include a metal, such as gold, copper or aluminum, or other conductive materials known to those having skill in the art.

Carbide-derived carbon, as described elsewhere herein, is a suitable microporous material for the electrochemical cells. Carbide-derived carbon is derived from titanium carbide can be especially suitable. In some embodiments, essentially all of the pores of the microporous material can be smaller than about 1 nm, less than about 0.9 nm, or even less than about 0.8 nm. Suitable electrolytes include solvated ions larger than the average pore size of the microporous material. As a non-limiting example, electrolyte tetraethylammonium tetrafluoborate (NEt₄BF₄) salt in acetonitrile is a suitable electrolyte. Other suitable electrolytes are known to those having skill in the art.

Additionally provided are methods for making electrochemical cells. These methods include connecting at least one electrode to at least one current collector, wherein the at least one electrode comprises a microporous composition characterized as having an average pore size of less than about 1.2 nm, as determined by the non-local density functional theory method analysis of nitrogen sorption isotherms; and contacting the at least one electrode with an electrolyte, wherein the electrolyte comprises a plurality of solvated ions, a plurality of unsolvated ions, or any combination thereof.

Suitable microporous compositions and methods for preparing such compositions are described elsewhere herein. An electrode can suitably be an negative electrode, a positive electrode, or any combination thereof.

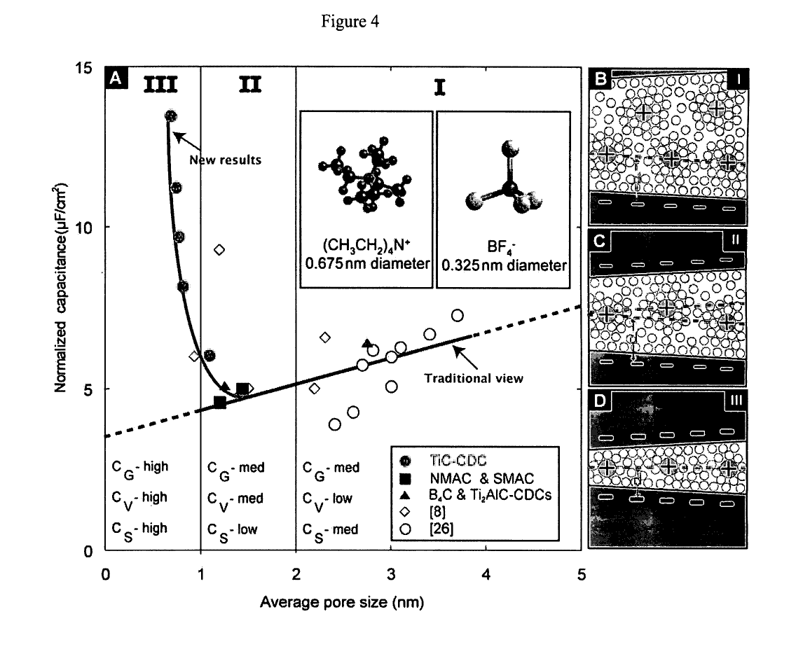

As discussed elsewhere herein, the traditional understanding of how porosity affects specific capacitance and frequency response posits that pores larger than the size of the electrolyte ion plus its solvation shell are required for both minimizing the characteristic relaxation time constant. Without being bound to any particular theory of operation, however, it is believed that pores smaller than the solvent shells surrounding ions in an electrolyte solution can lead to distortion of the solvent shell surrounding ions present in the electrolyte, which, as the solvent shell is stripped away, allows for closer approach of the ion center to the electrode surface and in turn allows for greater capacitance. This is shown schematically in FIG. 4, which illustrates the distortion of solvent shells surrounding ions with progressively smaller pores and illustrates the close approach of the ions to the electrode surface in such pores.

Accordingly, the average pore size of a suitable microporous composition can be approximately equal to about the average diameter of the solvated ions of the electrolyte. In other embodiments, the average pore size of the microporous composition is less than about the average diameter of the plurality of solvated ions of the electrolyte. In still other embodiments, the average pore size of the microporous composition is less than about 5 nm greater than the average diameter of the plurality of unsolvated ions of the electrolyte, or less than about 3 nm greater than the average diameter of the plurality of unsolvated ions of the electrolyte. As will be apparent to those of skill in the art, the pore size of the microporous composition may be chosen depending on the electrolyte of the electrochemical cell, or vice versa, so as to optimize the performance of the electrochemical cell.

The present invention also includes electrochemical cells made according to the described methods.

### EXAMPLES AND OTHER ILLUSTRATIVE EMBODIMENTS

The following are non-limiting examples and embodiments that are representative only and do not necessarily restrict the scope of the present invention.

TiC powder (Alfa Aesar #40178, particle size 2 micrometers, www.alfaaesar.com) was chlorinated at temperatures from 500° C. to 1000° C. in a horizontal tube furnace. B₄C and Ti₂AlC powders were also chlorinated at a synthesis temperature of 1000° C. Details of the chlorination technique have been reported previously (Chmiola et al., J. Power Sources, 2005). Residual chlorine and chlorides trapped in pores were removed by annealing in hydrogen for 2 hours at 600° C. Two commercially available activated carbons that are currently used in supercapacitors, one using a natural precursor (natural material precursor activated carbon, “NMAC”, Kuraray Corp., Japan, www.kuraray.co.jp, product YP17), and one using a synthetic precursor (synthetic material precursor activated carbon, “SMAC”, Kuraray Corp. product BP10), were also studied.

Argon sorption was conducted from relative pressure, P/P_{O}, of 10⁻⁶ to 1 to assess porosity and surface area data. Porosity analysis was carried out at liquid nitrogen temperature, approximately 195.8° C., on samples outgassed for at least 12 hours at 300° C. using a Quantachrome Autosorb-1. Isotherms of a representative sample showed increasing pore volume with increasing synthesis temperature (FIG. 5A). All isotherms were type I, showing the CDC to be microporous according to the IUPAC classification. At a 1000° C. chlorination temperature, there was slight hysteresis, showing a small amount of mesoporosity. Pore size distributions were calculated from Ar adsorption data using the nonlinear density functional theory (NLDFT) method (Ravikovitch, P. I and Neimark, A., Colloid Surface A, 2001, 11:18-188) provided by Quantachrome data reduction software version 1.27 (FIGS. 5B and 5C) and the SSA was calculated using the Brunauer, Emmet, Teller (BET) method (Brunauer et al., J. Am. Chem. Soc., 1938 60:309).

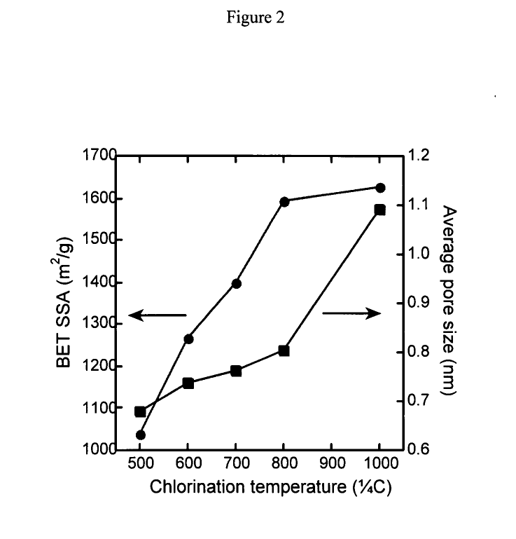

Non linear density functional (NLDFT) analysis of argon adsorption isotherms showed the width of the pore size distribution increased with synthesis temperature (FIGS. 5B and 5C), and the average pore size shifted to larger values (FIG. 2). FIGS. 5A, 5B, and 5C present porosity information resolved from gas sorption data. FIG. 5A shows isotherms for TiC-CDC synthesized in the 500° C. to 1000° C. range showed increasing pore volume with synthesis temperature. At synthesis temperatures below 1000° C., there was no hysteresis, indicating no pores larger than 2 nm. Pore size distributions for TiC-CDC synthesized at 500° C. (FIG. 5B) and TiC-CDC synthesized at 1000° C. (FIG. 5C) showed broadening with increasing synthesis temperatures. Minima in the plots are artifacts of the DFT calculation and not indicative of multi-modal pore size distributions.

The BET (Brunauer, Emmet, Teller) SSA showed a similar increase with temperature (FIG. 2). Two activated carbons utilized commercially in supercapacitors, referred to as NMAC (natural material precursor activated carbon) and SMAC (synthetic material precursor activated carbon) were also studied and served as a reference. The materials displayed average pore sizes of about 1.45 nm and 1.2 nm, respectively and SSA of about 2015 m²/g and 2175 m²/g, respectively. CDCs synthesized from B₄C and Ti₂AlC (Chmiola et al., Electrochem. Solid St. Let., 2005, 8:A357), having pore sizes of 1.25 nm and 2.25 nm, respectively, and SSA of 1850 m²/g and 1150 m²/g were also studied because their pore size is close to that of typical activated carbons. This showed CDC synthesized in the temperature range studies had a pore structure largely representative of a wide range of activated carbons, making it a good model system to study the effect of pore size on energy storage. Without being bound to any particular theory of operation, it is believed that as the pore size of CDC can be altered with a high degree of control, the material may be suitable for exploring trends not foreseeable with conventional activated carbons or carbon nanotubes.

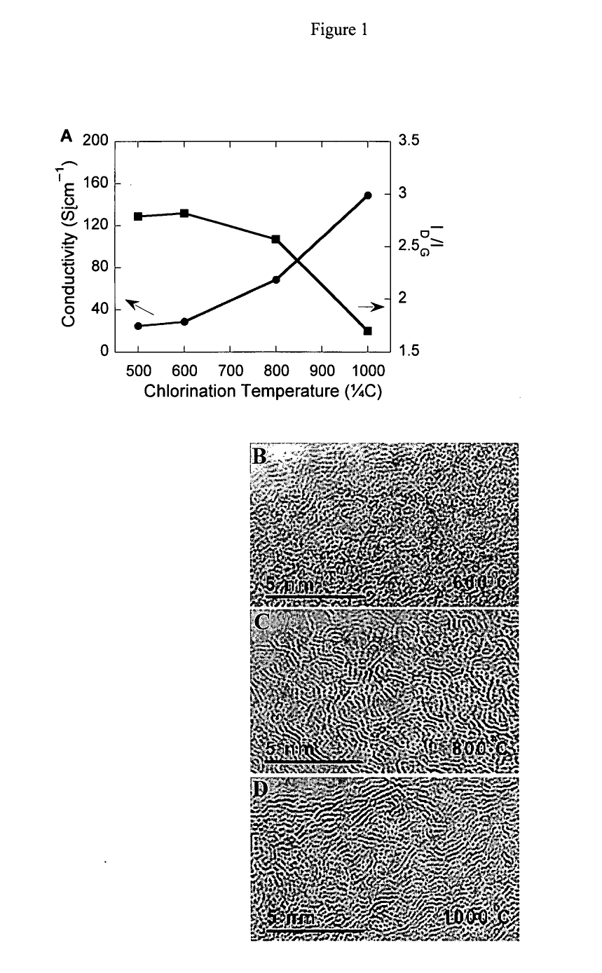

Raman spectroscopy of representative samples was performed using a Renishaw 1000 microspectrometer with Ar⁺ laser excitation (λ=514.5 nm) at 500× magnification. Analysis was done by fitting two Gaussian curves to the graphite band, G-band, at approximately 1580 cm⁻¹, and the disorder-induced D-band at approximately 1350 cm⁻¹ (Ferrari, A. C. and Robertson, J., Phys. Rev. Lett., 2000, B61:14095). The ratio of the area under each curve, termed the I_{D}/I_{G} ratio, gave a measure of graphene crystallite size (FIG. 1A). Conductivity was also measured using a 4-probe technique on carbon compacted under 10 MPa. Decreasing the I_{D}/I_{G} ratio corresponded to an increasing crystallite size and led to increasing electronic conductivity. The conductivities of SMAC and NMAC were also measured to be 13 S·cm⁻¹ and 19 S·cm⁻¹, respectively.

High resolution transmission electron microscopy (HRTEM) was also used to observe the CDC structure (See FIGS. 1B, 1C, 1D). The TEM samples were prepared by a 15-minute sonication of the CDC powder in isopropanol and deposition on a lacy-carbon coated copper grid (200 mesh). A field-emission TEM (JEOL 2010F) with an imaging filter (Gatan GIF) was used at 200 kV. It was observed that increasing the synthesis temperature increased order. No drastic structural changes occurred in the temperature range studied. Graphitization of TiC-CDC occurred, however, at synthesis temperatures of approximately 1200° C.

Raman spectroscopy showed a decreasing ID/IG ratio with increasing synthesis temperature, indicting increasing order. This increasing order was reflected in increasing conductivity with synthesis temperature. TEM micrographs of TiC-CDC produced at (FIG. 1B) 600° C., (FIG. 1C) 800° C., and (FIG. 1D) 1000° C. show slight ordering as evidenced by increasing length of graphite fringes, as well as their flattening. FIG. 2 provides porosity information resolved from gas sorption data. As shown, both the SSA and average pore size increased with synthesis temperature.

Supercapacitor cells (4 cm²) were assembled in a glove box under an argon atmosphere with O₂ and H₂O content of less than 1 ppm. Electrode films of the present invention were constituted of 95 wt % of CDC and 5 wt % of polytetrafluoroethylene (“PTFE”). The weight density of active material was kept constant at 15 mg/cm² leading to a thickness that varied between about 250 micrometers and about 270 micrometers. The active material was laminated onto a treated aluminum current collector (Portet et al., Electrochim. Acta, 2004, 49:905)). PTFE plates and stainless clamps were used to maintain the stack under pressure (5 kg/cm²). The cell was then immersed into an electrolyte consisting of a 1.5 M NEt₄BF₄ salt in acetonitrile and placed in an airtight box.

Electrochemical characterization was carried out using galvanostatic cycling with a BT2000 Arbin cycler at different current densities from 5 mA/cm² up to 100 mA/cm² between 0 and 2.3V. The Equivalent Series Resistance (ESR) was calculated during a 1 ms current pulse from the ohmic drop measured at 2.3V. The cell capacitance was calculated from the slope of the discharge curve from equation 2:

$$C = \frac{I}{( \frac{d V}{d t} )} \qquad ( 2 )$$

where C is the cell capacitance in Farad (F), I the discharge current in Ampere (A) and dV/dt the slope of the discharge curve in Volts per second (V/s).

The specific capacitance C_{mAM} in Farad per gram of active material (F/g) was related to the capacitance of the cell, C, by:

$${C}_{{m}_{AM}} = \frac{2 C}{{m}_{AM}} \qquad ( 3 )$$

where m_{AM} is the weight (g) per electrode of the active material, i.e. 60 mg. Similarly, the volumetric capacitance was calculated from equation 4:

$${C}_{{V}_{AM}} = \frac{2 C}{{V}_{AM}} \qquad ( 4 )$$

where V_{AM} is the volume of the active material layer, which varies with processing temperature.

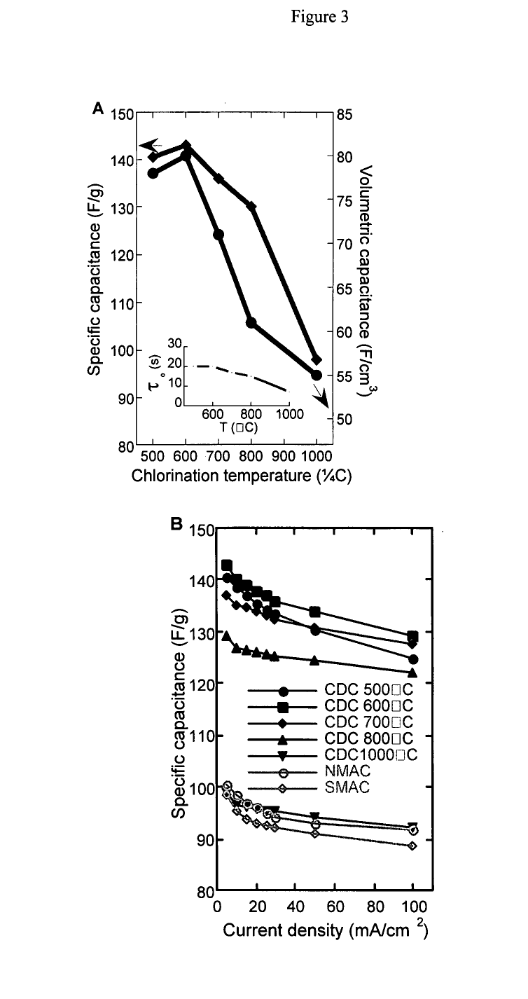

FIGS. 3A and 3B show the electrochemical behavior of TiC-CDC synthesized in the 500° C. to 1000° C. range. As shown in FIG. 3A, specific capacitance and volumetric capacitance both decreased with synthesis temperature. Maximum capacitance was at 600° C. synthesis temperature. NAMAC and SMAC characteristics are 100 F/g, 35 F/cm³ and 95 F/g, 45 F/cm³, respectively, under the same conditions. The plot of characteristic time constant, τₒ, versus synthesis temperature (inset), showed slightly increasing frequency response with temperature. Comparing TiC-CDC charge-discharge behavior with commercially available carbons (FIG. 3B), showed that a 50% improvement over commercial materials. There was also very little capacitance fading at current densities up to 100 mA/cm² for even the 500° C. sample.

As discussed elsewhere herein, the traditional understanding of how porosity affects specific capacitance and frequency response states that pores larger than the size of the electrolyte ion plus its solvation shell are required for both minimizing the characteristic relaxation time constant, τₒ (Taberna et al., J. Electrochem. Soc., 2003 150:A292), the minimum time needed to discharge all the energy from the supercapacitor cell with an efficiency higher than 50%, and maximizing its specific capacitance (Endo et al., J. Electrochem. Soc., 2001 148:A910). Therefore, as conductivity, surface area and average pore size all scaled with synthesis temperature, it was expected in a first approach that CDC synthesized at 1000° C. would exhibit the shortest τₒ and the highest capacitance. Indeed, increasing the pore size from 0.68 nm to 1.1 nm caused a slight decrease in τₒ (FIG. 3A inset), as expected. However, even for the sample with the smallest pore size (500° C. TiC-CDC), there was only a minimal decrease in specific capacitance with increasing current density from 5 mA/cm² to 100 mA/cm² (FIG. 3B), which highlighted the minimal change in frequency response behavior. NMAC and SMAC, having similar pore size to 1000° C. TiC-CDC, had similar time constants to 800° C. TiC-CDC, owing to CDC's higher bulk conductivity. The opposite trend was found in the behavior of capacitance, however: both the specific (gravimetric) and volumetric (capacitance per unit bulk volume of carbon) capacitances decreased with increasing synthesis temperature (FIG. 3A). Increasing the chlorination temperature from 500° C. to 1000° C., the specific capacitance decreased by approximately 50%, from approximately 140 F/g to approximately 100 F/g though the SSA increased by nearly 75% from 1000 m²/g to 1800 m²/g. This capacitance decrease in high surface area carbons has been attributed to the development of surface area believed to be inaccessible to electrolyte ions due to the small size of the pores (Shi, H., Electrochim. Acta, 1995, 41:1633)). As discussed elsewhere herein, however, the increasing surface area at elevated synthesis temperatures arises as a result of larger diameter pores (FIG. 2). Therefore, it cannot be as simply explained as previous studies suggested.

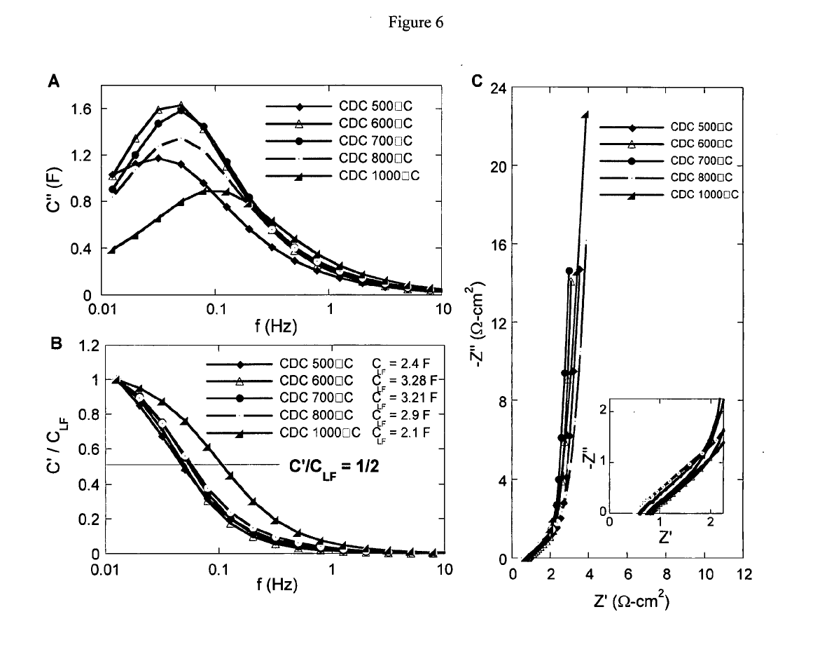

Electrical Impedance Spectroscopy (EIS) was performed on two-electrode TiC-CDC cells at a DC bias of 2.3 V by applying a 10 mV RMS sine wave at frequencies varying from 10 kHz to 10 mHz. The resulting signal was separated into a real (Z′) impedance which is completely in phase with the applied signal and imaginary (Z″) impedance which is 90° out of phase with the applied signal. This information, along with the phase angle dependence on frequency was translated into plots of Z′ and Z″, termed Nyquist plots (FIG. 6C), and plots of the real (C′) (FIG. 6B) and imaginary (C″) (FIG. 6A) portions of capacitance, as described by Taberna, et al. (Taberna et al., J. Electrochem. Soc., 2003, 150:A292).

FIGS. 6A, 6B, and 6C show frequency response behavior of TiC-CDC. Imaginary capacitance (FIG. 6A) versus frequency showed maxima occur at increasing frequency with increasing synthesis temperature. Plots of real capacitance (FIG. 6B) normalized by capacitance measured at 1 mHz (CLF) versus frequency showed that the intersection with C′/C_{LF}=½ followed a similar trend as FIG. 6A. Nyquist plots, FIG. 6C, showed behavior consistent with DC measurement. No high frequency loop was visible, indicating carbon/current collector contact.

FIGS. 4A through 4D illustrate specific capacitance normalized by BET SSA for the carbons in the study and two other studies with identical electrolytes. FIG. 4A shows the normalized capacitance decreased with pore size until a critical value is reached, unlike traditional understanding which assumed capacitance continually decreased. It would be expected that as the pore size becomes large enough to accommodate diffuse charge layers, the capacitance would approach a constant value. C_{G}, Cᵥ and Cₛ are gravimetric, volumetric and normalized capacitances, respectively. Cartoons showing solvated ions residing in pores with distance between adjacent pore walls (FIG. 4B) greater than 2 nm, (FIG. 4C), between 1 nm and 2 nm and (FIG. 4D) less than 1 nm illustrate this behavior schematically.

While not being bound to any particular theory, it appears that for TiC-CDC, increasing the pore size has a detrimental effect on the normalized capacitance. While high capacitance of some carbons with sub-nanometer pore size have been noted previously, such results have been largely disregarded (Vix-Gueryl et al., Carbon, 2005 43:1293).

Data in FIG. 4A as well as data from other studies (Gamby et al. J., Power Sources, 2001 101:109; Vix-Gueryl et al., Carbon, 2005, 43:12938, 24) for CDC with a larger pore size show that there is a decreasing normalized capacitance trend with reducing pore size to approximately 1 nm. This trend highlights the traditional understanding of porosity in supercapacitors: decreasing the pore size decreases the capacitance. In fact, TiC-CDC synthesized at 1000° C., B₄C-CDC, Ti₂AlC-CDC, NMAC and SMAC all followed this traditional behavior, which demonstrated that this size effect was independent of the carbon material used.

As demonstrated herein, however, decreasing the pore size to the sub-nanometer range, as evidenced by TiC-CDC synthesized below 1000° C., results in a reversal of this trend and a sharp increase in capacitance with decreasing pore size. Without being bound to any particular theory or more of operation, these results challenge the long-held belief that pores smaller than the size of solvated electrolyte ions are incapable of contributing to charge storage. Evidence provided herein that sub-nanometer pores play a crucial role in achieving high energy storage capacity could finally help bring supercapacitors to a state of large-scale acceptance.

In region I of FIG. 4A, when pores were larger than twice the size of the solvated ions (FIG. 4B), there was a contribution to capacitance from compact layers of ions residing on both adjacent pore walls. Though the diffuse layer of charge, described by Grahame (Grahame, D. C. Chemistry Review 1947 41:441), was absent or diminished in size, the capacitance was largely unaffected as the compact layer encompasses much of the potential drop. Decreasing the pore size to less than twice the solvated ion size (FIG. 4C) reduced the normalized capacitance (FIG. 4A, region II) as compact ion layers from adjacent pore walls impinged and the surface area usable for double layer formation was reduced. This largely accounts for the decrease in specific capacitance with pore size reduction found in literature and shown in FIG. 4A for pore sizes greater than approximately 1 nm. Further decrease of pore size to less than the solvated ion size (FIG. 4D, region III) induced very large electric fields, and hence large driving forces for ion motion into the pore.

Theoreticians such as Dzubiella et al. showed that under a potential, there is significant ion motion in pores smaller than the size of their solvation shells (J. Chem. Phys., 2005, 122:23706). The solvation shell becomes highly distorted as the ion is squeezed through the pore in much the same manner as a balloon distorts when squeezed through an opening smaller than its equilibrium size. The distortion of solvation shells in small cylindrical pores of carbon nanotubes was also reported recently (DiLeo, J. M and Maranon, J., J. Mol. Struct., 2004, 729:53; Tripp et al., Phys. Rev. Lett., 2004, 93:168104). Without being bound by any particular theory of operation, such distortion would allow closer approach of the ion center to the electrode surface, which by Eq. (1) leads to improved capacitance. Unlike templated carbons that achieve improved specific capacitance via increasing pore size (FIG. 4A region I and FIG. 4B), whereby the volumetric capacitance is low, using microporous carbons with sub-nanometer pores, as taught herein, allows a doubling of volumetric capacitance (FIG. 3B).

What is claimed:

1. A composition, comprising:
a microporous carbon composition comprising a plurality of pores and characterized as having an average characteristic cross-sectional dimension, as determined by the non-local density functional theory method analysis of nitrogen sorption isotherms, of less than about 1 nm.

2. The composition of claim 1, wherein the plurality of pores is characterized as being substantially slit-shaped.

3. The composition of claim 1, wherein the plurality of pores is characterized as being substantially cylindrical in shape.

4. The composition of claim 1, wherein the microporous carbon composition consists essentially of carbide-derived carbon.

5. The composition of claim 1, wherein the microporous carbon composition contains essentially no ordered graphite.

6. The composition of claim 1, wherein the plurality of pores has an average characteristic cross-sectional dimension as determined by the non-local density functional theory method analysis of nitrogen sorption isotherms, of less than about 2 nm.

7. The composition of claim 1, wherein the microporous carbon composition is characterized as having a unimodal pore size distribution.

8. The composition of claim 1, wherein the microporous carbon composition is substantially disordered.

9. The composition of claim 1 characterized as having an average pore size less than about 0.9 nm.

10. The composition of claim 1 characterized as having an average pore size less than about 0.8 nm.

11. The composition of claim 1 characterized as having a surface area calculated by the Brunauer, Emmett and Teller method in the range of from about 800 m²/g to about 3000 m²/g.

12. The composition of claim 1 characterized as having a surface area calculated by the Brunauer, Emmett and Teller method in the range of from about 1000 m²/g to about 2000 m²/g.

13. The composition of claim 1 characterized as having a specific capacitance greater than about 90 F/g in an organic electrolyte.

14. The composition of claim 1 characterized as having a gravimetric capacitance by the Brunauer, Emmett and Teller method of greater than about 5 μF/cm².

15. A method of making a microporous carbon composition characterized as having an average pore size of less than about 1 nm, comprising:
halogenating a metal carbide powder at a temperature in the range of from about 500° C. to about 1000° C. to give rise to a microporous carbide-derived carbon composition; and
annealing the microporous carbide-derived carbon composition to remove residual chlorine and chlorides trapped in the pores of the microporous carbide-derived carbon composition.

16. The method of claim 15, wherein the annealing comprises exposing the microporous carbide-derived carbon composition to a flow of hydrogen, nitrogen, ammonia, argon, helium, or any combination thereof.

17. The method of claim 16, wherein the flow is in the range of from about 5 cubic centimeters per minute to about 1000 cubic centimeters per minute.

18. The method of claim 15, wherein the annealing for about from 5 minutes to about 600 minutes.

19. The method of claim 15, wherein the annealing occurs in the range of from about 350° C. to about 1000° C.

20. A composition made according to the method of claim 15.

21. An electrode, comprising:
a conductive microporous carbon composition characterized as having an average pore size of less than about 1 nm.

22. The electrode of claim 21, wherein the microporous carbon composition consists essentially of carbide-derived carbon.

23. The electrode of claim 21, wherein the microporous carbon composition contains essentially no ordered graphite.

24. The electrode of claim 21, wherein essentially all of the pores are smaller than about 2 nm.

25. The electrode of claim 21, wherein the microporous carbon composition is characterized as having a unimodal pore size distribution.

26. The electrode of claim 21, wherein the microporous carbon composition is substantially disordered.

27. The electrode of claim 21, wherein the microporous carbon composition is characterized as having an average pore size less than about 0.9 nm.

28. The electrode of claim 21, wherein the microporous carbon composition is characterized as having an average pore size less than about 0.8 nm.

29. The electrode of claim 21, wherein the microporous carbon composition is characterized as having a surface area calculated by the Brunauer, Emmett and Teller method in the range of from about 1000 m²/g to about 3000 m²/g.

30. The electrode of claim 21, wherein the microporous carbon composition is characterized as having a specific capacitance greater than about 90 F/g.

31. The electrode of claim 21, wherein the microporous carbon composition is characterized as having a normalized capacitance greater than about 5 μF/cm².

32. The electrode of claim 21, further comprising a binder.

33. A method of making an electrode, comprising:
preparing a film comprising a microporous carbide-derived carbon composition characterized as having an average pore size of less than about 1 nm.

34. An electrode made according to the method of claim 33.

35. An electrochemical cell, comprising:
at least one electrode comprising a microporous material characterized as having an average pore size of less than about 2 nm;
at least one current collector in contact with the at least one electrode, wherein the at least one current collector comprises a conducting material; and
an electrolyte directly contacting the at least one electrode.

36. The electrochemical cell of claim 35, comprising at least two electrodes, wherein at least one of the at least two electrodes comprises a microporous composition characterized as having an average pore size of less than about 2 nm and at least two current collectors, and wherein each current collector is in electrical connection with an electrode, and wherein the electrolyte directly contacts at least one of the electrodes.

37. The electrochemical cell of claim 35, wherein the electrochemical cell is capacitor, a supercapacitor, or any combination thereof.

38. The electrochemical cell of claim 35, wherein the microporous composition comprises carbide-derived carbon.

39. The electrochemical cell of claim 38, wherein the carbide-derived carbon is derived from titanium carbide.

40. The electrochemical cell of claim 35, wherein essentially all of the pores of the microporous composition are smaller than about 1 nm.

41. The electrochemical cell of claim 35, wherein the average pore size of the microporous material is less than about 0.9 nm.

42. The electrochemical cell of claim 35, wherein the average pore size of the microporous material is less than about 0.8 nm.

43. The electrochemical cell of claim 35, wherein the electrolyte comprises solvated ions larger than the average pore size of the microporous composition.

44. A method for making an electrochemical cell, comprising:
adhering at least one electrode to at least one current collector, wherein the at least one electrode comprises a microporous composition characterized as having an average pore size of less than about 1.2 nm, as determined by the non-local density functional theory method analysis of nitrogen sorption isotherms; and
contacting the at least one electrode with an electrolyte, wherein the electrolyte comprises a plurality of solvated ions, a plurality of unsolvated ions, or any combination thereof.

45. The method of claim 44, wherein the microporous composition is characterized as derived from a carbide.

46. The method of claim 44, wherein the at least one electrode comprises at least one negative electrode, at least one positive electrode, or any combination thereof.

47. The method of claim 44, wherein the average pore size of the microporous composition is approximately equal to about the average diameter of the solvated ions of the electrolyte.

48. The method of claim 44, wherein the average pore size of the microporous composition is less than about the average diameter of the plurality of solvated ions of the electrolyte.

49. The method of claim 44, wherein the average pore size of the microporous composition is less than about 5 nm greater than the average diameter of the plurality of unsolvated ions of the electrolyte.

50. The method of claim 44, wherein the average pore size of the microporous composition is less than about 3 nm greater than the average diameter of the plurality of unsolvated ions of the electrolyte.

51. An electrochemical cell made according to the method of claim 44.
